(19) United States
(12) Patent Application Publication
(10) Pub. No.: US 2005/0146784 A1
(43) Pub. Date: Jul. 7, 2005

(54) Confocal microscope having multiple independent excitation paths

(76) Inventor: William I. Vogt, Baraboo, WI (US)

Correspondence Address: Joseph T. Leone;DeWitt Ross & Stevens S.C., 8000 Excelsior Drive, Madison, WI, 53717, US

(21) Appl. No.: 11/031,089

(22) Filed: Jan. 6, 2005

Related U.S. Application Data
(60) Provisional application No. 60/534,634, filed on Jan. 6, 2004.

(51) Int. Cl. G02B 21/00

(52) U.S. Cl. 359/368; 359/204

(57) ABSTRACT

A confocal microscope including a first light source for emitting an incoming light beam with which a sample to be observed is irradiated; a scan engine dimensioned and configured to scan the incoming light beam prior to its irradiating the sample, thereby generating a scanned incoming light beam; a second light source for emitting an excitation light beam with which the sample is radiated; and a polarizing beam-combining cube and/or dichroic mirror for combining the scanned incoming light beam and the excitation light beam is disclosed.

### CROSS-REFERENCE TO RELATED APPLICATIONS

Priority is hereby claimed to provisional patent application Ser. No. 60/534,634, filed Jan. 6, 2004, the entire content of which is incorporated herein by reference.

### FIELD OF THE INVENTION

The invention is directed to confocal microscopes and sub-assemblies used in confocal microscopes. In one embodiment of the invention, the confocal microscope includes multiple independent excitation paths and emission paths. The preferred embodiment of the microscope includes a beam-splitter and a beam combiner (such as a polarizing beam combining cube or a dichroic mirror) to direct independently two distinct incoming light beams (having the same or different wavelengths) onto a sample to be imaged. At the same time, the microscope maintains the normal collection efficiency of the returning fluorescent emission. The returning fluorescent emission is preferably captured by an imaging device, such as a charged-coupled device (CCD), or converted into stored electronic signals. In another embodiment of the invention, the confocal microscope includes an additional controller which scans the excitation light beam(s). In combination, the confocal microscope provides simultaneous imaging and photoactivation or photoexcitation of a sample, while also providing an unperturbed return path for the emission light beam.

### BACKGROUND

Confocal microscopy has revolutionized the basic biological sciences. The confocal microscope is a powerful tool that can generate images of the interior of living cells. The ability to generate real-time images of intracellular phenomena provides significant insight into the causes of physiological disorders, as well as a means to evaluate drug therapies at the sub-cellular level.

Confocal microscopes are well known devices. The basic elements of a confocal microscope are illustrated schematically in FIG. 1. In FIG. 1, a light source 1, such as a high-intensity lamp, laser, or light-emitting diode, generates a light beam that passed through a pinhole 2, through dichroic mirror 3, and through objective lens 12, thus forming a spot of focused light on the surface of a sample 10. The objective lens 12 is an aberration-corrected lens.

Light reflected from the surface of the sample 10 (or light generated by a fluorescent or chromophoric dye present in the sample) passes back through the objective lens 12, and is reflected by the dichroic mirror 3 and focused. A pinhole 5 is disposed at the focal point. The focused light coming from the sample, having passed through the pinhole 5, is detected by a photodetector 26.

In a conventional scanning confocal microscope, the sample 10 is rasterized to generate a two-dimensional image of the surface of the sample. To scan the light path across the sample systematically (to generate the rasterized image), a conventional confocal microscope uses a sub-assembly of galvanometers or acousto-optical scanners to manipulate the light path in the X and Y directions. Generally, when using the conventional arrangement shown in FIG. 1, and using galvanometers to scan the light path, the image acquisition rate is about 1 image/sec. If a combination of acousto-optical and galvanometers are used to scan the image, the image acquisition rate is about 30 images/sec. These image acquisition rates limit the usefulness of conventional confocal microscopy because generating a complete image of the sample is too slow.

In an effort to simplify the instrumentation and to speed the image acquisition rate, confocal microscopes wherein the pinhole 5 of FIG. 1. is replaced by a spinning disk having a plurality of apertures passing therethrough are known. In these “rotating disk” confocal microscopes, the single pinhole 5, is replaced by a rotating disk having a pattern of annular apertures therein. The pattern is in the shape of an Archimedean spiral. The apertures that are diametrically opposite one another on the disk are on identical radii, and the pattern as a whole has a central symmetry. This type of disk is generally known as a Nipkow disk. Nipkow disks have conventionally been fabricated from a copper foil sheet stretched over a retaining ring and having holes etched into the copper sheet. See, for example, U.S. Pat. No. 4,802,748, issued Feb. 7, 1989, to McCarthy et al.; see also U.S. Pat. No. 3,517,980, issued Jun. 30, 1970, to Petran et al.

For other examples of confocal microscopes utilizing a Nipkow disk, see, for example, U.S. Pat. No. 6,191,885 to Kitagawa, issued Feb. 20, 2001, and U.S. Pat. No. 6,204,962 to Kawamura, issued Mar. 20, 2001. These two patents describe a multi-beam optical arrangement wherein a rotating disk scanner is used to scan the laser beam across the sample being viewed. The most significant feature of this type of confocal microscope is that it enables direct observation and direct photography of the sample. In short, this type of multi-beam confocal microscope can be used in the same fashion as a conventional light microscope.

Spinning disk confocal microscopes, however, have several design limitations. Absent complicated realignment of the system, spinning disk confocal microscope designs are restricted to using a single confocal aperture size. Several designs are vulnerable to back-reflection of the excitation light; that is, these designs are prone to having excitation light “leak” into the detection pathway. This is especially so when a spinning disk device is used in reflected light mode. All disk scanners are limited to using a two-dimensional detector array, such as a CCD camera, to capture the image information. Given these design limitations of the prior art disk scanning confocal instruments, there exists several unmet needs for an instrument that combines the speed and simplicity of the disk scanning devices with the flexibility of the laser scanning systems.

While confocal microscopes can be used to view conventional samples, they have been found to have particular utility in real-time characterization of living cells. This is often done using dyes, fluorophores, or other reagents having labeled or photoactivatable moieties. For example, confocal scanning laser microscopes (CSLM) can be used to study pharmacokinetics. This is often done using photoactivatable or caged reagents. The reagents are activated or uncaged using an excitation beam, and the resulting signals are then compiled into an image. One notable protocol is designated FRAP: fluorescence recovery after bleaching. The FRAP technique a scanning laser excitation beam is used to bleach a fluorescent molecule present in the sample. The recovery of fluorescence is then monitored and an image generated therefrom.

These techniques, while extremely powerful, are not particularly easy to execute. Using a conventional confocal microscope, there are three basic steps required to produce confocal image when a photoactivatable or photoexcitable reagent is used. First, the sample is viewed in the conventional, confocal mode, at a first wavelength, in order simply to focus the microscope. Then, with the microscope properly focused, an activation (or excitation) beam at a second given wavelength is directed onto the sample to activate (or excite) the photoactivatable (photoexcitable) reagent. This causes a specific photo-initiated reaction to occur in the sample, depending on the nature of the reagent and the sample being examined. The sample is then confocally imaged using the first wavelength (or some other wavelength which is normally different from the activation/excitation wavelength). The return signal (or emission signal) from the sample is then directed to a suitable detector. (There are many permutations to this basic approach. In FRAP, for example, the activation beam is a high-power beam of the same wavelength as the imaging beam.) In whatever method being implemented, there must be a high level of coordination between focusing the device, adding a photo-reagent to the sample, impinging an activation or excitation beam onto the sample (at the proper wavelength and intensity), and then gathering a confocal image of the sample. The image must be gathered in a timely fashion, and the image ultimately generated must be clear and in focus to be useful.

Due to the need to integrate several signal processing and control technologies (e.g., light sources, optics, high-gain/low-noise electronics, galvanometers, means for photon detection, means for signal storage, etc.), the cost of CSLM's is considerable, oftentimes well over $100,000 in year 2004 dollars. Due to this cost, most confocal microscopes are not available to individual researchers, but must be purchased and administered by multi-user facilities. Due to the complexity of the devices, specially trained personnel are also generally need to perform specialized procedures such as FRAP.

### SUMMARY OF THE INVENTION

The crux of the invention is a confocal microscope comprising a first scan engine which is dimensioned and configured to scan a first incoming light beam prior to the first incoming light beam irradiating a sample. This results in a scanned incoming light beam. A beam-combiner is operationally linked to the first scan engine. The beam-combiner is dimensioned and configured to combine the scanned incoming light beam with a second incoming light beam. In this fashion, two (or more) independent incoming light beams can be directed onto the sample. In the preferred embodiment, the beam-combiner is a polarizing beam-combining cube operationally linked to a dichroic mirror.

The confocal microscope of the present invention may further comprise a second scan engine which is dimensioned and configured to scan the second incoming light beam. In the preferred embodiment of the invention, the first scan engine and the second scan engine are independently selected from the group consisting of a galvanometer-controlled mirror, a piezoelectric-controlled mirror, an acousto-optical deflector, a polygonal scanner, a diffraction grating, and a microelectromechanical system.

The confocal microscope of the present invention may further comprise a first light source for generating the first incoming light beam, wherein the first light source is operationally linked to the first scan engine. The microscope may also include a second light source for generating the second incoming light beam, wherein the second light source is operationally linked to a second scan engine (or is operationally linked directly to the beam-combiner, without an intervening scan engine).

In yet another embodiment of the invention, the confocal microscope comprises a first light source for generating a first incoming light beam. The first light source is operationally linked to a first scan engine which is dimensioned and configured to scan the first incoming light beam prior to the first incoming light beam irradiating a sample. This yields a scanned incoming light beam, as noted earlier. The microscope further comprises a second light source for generating a second incoming light beam. Here, the second light source is operationally linked to a beam-combiner, and the beam-combiner is operationally linked to the first scan engine. The beam-combiner is dimensioned and configured to combine the scanned incoming light beam with the second incoming light beam (which in this embodiment is not scanned).

Still another embodiment of the invention is a confocal microscope comprising a first light source for generating a first incoming light beam, wherein the first light source is operationally linked to a first scan engine dimensioned and configured to scan the first incoming light beam prior to the first incoming light beam irradiating a sample, thereby generating a scanned incoming light beam; a second light source for generating the second incoming light beam, wherein the second light source is operationally linked to a second scan engine dimensioned and configured to scan the second incoming light beam to yield a scanned second incoming light beam; and a beam-combiner which is operationally linked to the first scan engine and the second scan engine, wherein the beam-combiner is dimensioned and configured to combine the first scanned incoming light beam with the second scanned incoming light beam.

In the embodiments that include two (or more) light sources, the first light source is dimensioned and configured to generate a first incoming light beam of a first wavelength and the second light source is dimensioned and configured to generate a second incoming light beam of a second wavelength. The first wavelength and the second wavelength can be the same or different.

In the preferred embodiment, the means for combining the scanned incoming light beam and the excitation light beam is a polarizing beam combining cube operationally linked to a dichroic mirror. The two beams can also be combined using a combination of dichroic mirrors. As used throughout the present specification, the term “operationally linked” means that the noted elements are either optically linked, electronically linked, physically linked, or in any other fashion (without limitation) linked to one another so that they operate in cooperation to cause a stated result or otherwise to function as stated. Elements that are “operationally linked” such as lenses and mirrors, may have other elements optically, electronically, or physically disposed between them. When used with reference to a beam path, “operationally linked” explicitly means that the beam path passes through, is reflected from, or is otherwise operated upon by both elements (either with or without intervening elements).

In another embodiment of the invention, the microscope further comprises a second scan engine dimensioned and configured to scan the excitation light beam. Both the first scan engine and the second scan engine are independently (and preferably) selected from the group consisting of a galvanometer-controlled mirror, a piezoelectric-controlled mirror, an acousto-optical deflector, a polygonal scanner, a diffraction grating, and a microelectromechanical system. This list is illustrative, and non-limiting.

Using this arrangement of elements, the incoming light beam can have a wavelength that is the same as the wavelength of the excitation light beam or which is different than the wavelength of the excitation light beam.

In another embodiment of the invention, the microscope comprises a microscope having a light source for emitting a first incoming light beam with which a sample to be observed is irradiated (and the sample thereby generates a return light beam). A fixed and immovable aperture plate having more than one aperture defined therein is disposed in a position within the incoming light beam such that the incoming light beam is spatially filtered as it passes through the array of apertures. A first means for scanning is provided that scans the spatially filtered incoming light beam from the aperture plate across the sample and de-scans the return light beam from the sample. A dichroic filter is disposed within both the incoming light beam the return light beam paths such that the incoming light beam is reflected by the dichroic to the sample, while the return light beam passes through the dichroic filter, whereby the incoming light beam and the return light beam are diverged.

The design of the optical path described herein provides several advantages over previous confocal microscopes. A primary advantage is that by maintaining separate incoming and return light paths through the scan engine, a second beam of light, of the same or different wavelength, can be added to the incoming path (for photoexcitation and photoactivation experiments, two-photon imaging, FRAP, and other imaging protocols).

The confocal microscope disclosed herein can also be adapted to allow in vivo, physiologic studies, including use with photoactivation and photoexcitation for selectively photolabeling cells and proteins, molecular studies using caged compounds, fluorescence energy transfer (FRET), and fluorescence recovery after photo-bleaching (FRAP) investigations. These applications of the invention provide increased flexibility for the user as compared to a conventional confocal microscopes because the present microscope must be optically configured to carry both the effector wavelength and the excitatory wavelength.

Particular advantage accrues when the invention is used in FRAP studies. In this embodiment the excitation path is kept separate from the emission path through the scan engine. The two paths are then combined before entering the microscope. By keeping the two paths separate, a second excitation beam of the same wavelength as the first is added without losing fluorescent emission collection efficiency and/or excitation input efficiency. The beam combining is accomplished by using a polarizing beam splitter cube and an appropriate dichroic mirror to bring the beam paths together.

Thus, the present invention provides increased flexibility for the user as compared to a conventional confocal microscope. For example, the present microscope can be configured to provide inputs through two separate optical fibers, the first to an imaging path and the second to an activation/excitation path. When this design is employed, the image can be obtained by galvanometer or the light redirected for point imaging with a motorized aperture plate. In particular instances the motorized aperture plate can be used for imaging localized micro-domains with avalanche photodiode detection. In addition, by splitting a single laser beam between two optical fibers, greater flexibility is obtained when using the laser for FRAP studies.

These advantages are further illustrated when used in uncaging and bleaching experiments, which require very expensive, high-power lasers. In this process, a short pulse or flash of light is focused onto a position in a sample. Oxidation-inhibited compounds (caged compounds) are photolysed by the flash of light and are oxidized with a concurrent fluorescent emission. Photoactivatable caged compounds that are biologically inactive until exposed to ultraviolet light can be activated by flash photolysis. The confocal epifluorescence microscope is then used to provide an image of the fluorescence emitted from the specimen in response to the pulse of UV light focused onto a small area in the specimen. These techniques allow the temporal identification of the molecular interactions resulting from the release of, for example Ca²⁺ on Ca²⁺-dependent K⁺ channels, inositol 1,4,5 triphosphate (IP3) in neuronal cells, and the effects of other compounds on intracellular mechanisms. In these systems it necessary to have a single instrument that can provide the appropriate illuminating wavelength to uncage the effector compound and a confocal imaging apparatus of the appropriate wavelength to image the emitted energy from the fluorescing molecule.

In addition, further advantages of the optical layout can be realized by the versatility of the second beam. For example, the second beam can be stationary or scanned independently of the first beam. Further, with the appropriate dichroic selection, the second beam can be a different wavelength than the first beam. The second input provides a means to inject a continuous wave laser or a pulsed beam laser to be used simultaneously with the original imaging path for single- or two-photo imaging, ablation and photoactivation experiments, etc.

### BRIEF DESCRIPTION OF THE FIGURES

FIG. 1 is a schematic representation of the light path of a prior art confocal microscope.

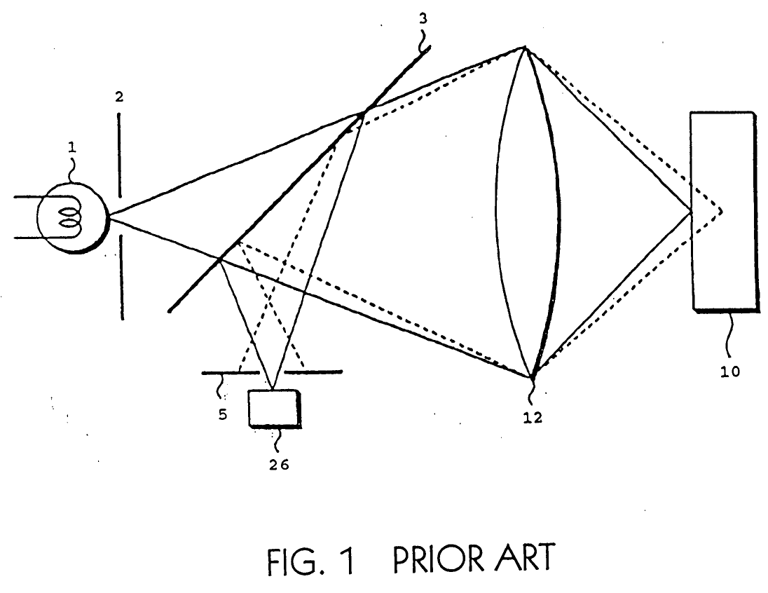

FIG. 2 is a perspective view of the preferred embodiment of the invention, and illustrates a scan engine operationally linked to a polarizing beam-combining cube and beam-splitting dichroic mirror.

FIG. 3 is a perspective view of a more complete beam path of the embodiment shown in FIG. 2.

FIG. 4 is a top plan schematic of a preferred embodiment of the present invention.

FIG. 5 is a perspective view taken from the opposite side of the device as shown in FIG. 3.

### DETAILED DESCRIPTION OF THE INVENTION

As noted above, the preferred embodiment of the invention is a microscope comprising a first light source for emitting an incoming light beam with which a sample to be observed is irradiated. This first incoming light beam is passed through a first scan engine. The scan engine is dimensioned and configured to scan the incoming light beam prior to its irradiating the sample (thereby generating a scanned incoming light beam). The scanned incoming light beam is ultimately swept or scanned across the sample, thereby generating a return light beam that is ultimately directed to an eye-piece, a transducer, a video camera, or any other means or structure dimensioned and configured to capture and store the image so generated.

The preferred embodiment of the invention also includes a second light source for emitting an excitation light beam with which the sample is irradiated and beam-combiner for combining the scanned incoming light beam and the excitation light beam. The excitation light beam is distinct and separate from the scanned incoming light beam. The two beams are combined, preferably by means of a polarizing beam-splitter in combination with a suitable dichroic mirror, and the combined beam is then used to irradiate the sample. Note that the wavelengths of the incoming light beam and the excitation light beam can be the same or different.

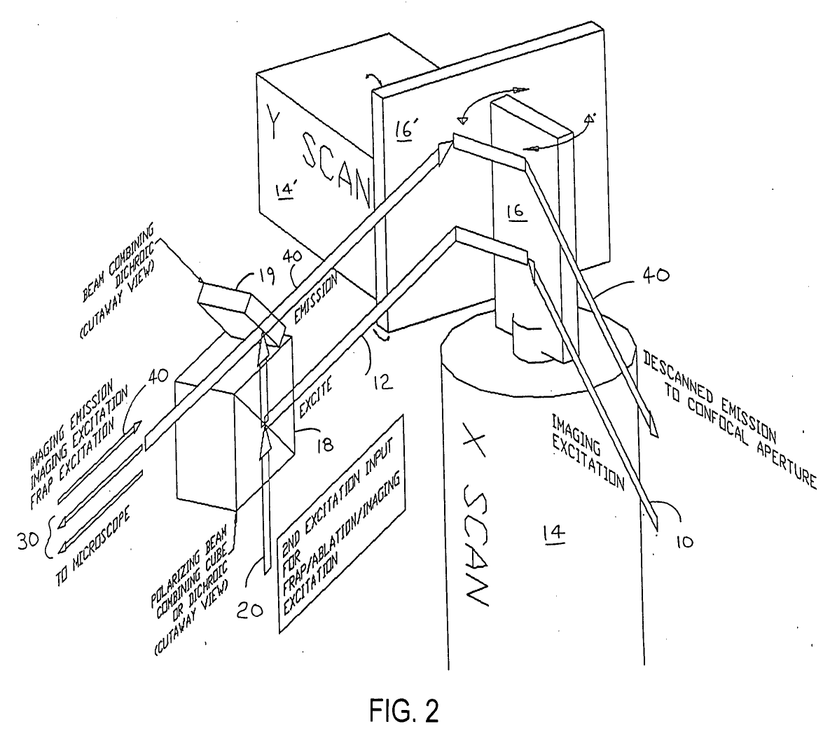

A schematic view of the preferred embodiment is depicted in FIG. 2. In FIG. 2, a first light source, not shown in the figure, emits an incoming light beam 10 with which a sample to be observed is irradiated. The incoming light beam 10 is passed through a scan engine comprised of an X-scanner 14 and an X-scanner mirror 16, and a Y-scanner 14′ and a Y-scanner mirror 14′. In combination, elements 14, 16, 14′ and 16′ define the scan engine. The scan engine is dimensioned and configured to sweep the incoming light beam 10 in a predetermined (or user-defined) pattern across the sample to be irradiated. Any means or structure for scanning the incoming light beam 10 across the sample will function in the present invention. Thus the terms “scan engine” encompasses any structure now known or developed in the future that is dimensioned and configured to sweep the incoming light beam 10 in a predetermined or user-defined pattern.

As shown in FIG. 2, the X-scanner 14 and Y-scanner 14′ are depicted as galvanometer control elements, with their associated mirrors 16 and 16′ rotationally linked thereto. As shown in FIG. 2, the Y-scanner mirror 16′ rotates in the Y-plane (as shown by the small arrows at the top and bottom of the mirror 16′) and the X-scanner mirror 16 rotates in the X-plane (as shown by the arrows at the top of the mirror 16).

The scan engine/means for scanning can be selected from any means now known in the art or developed in the future for scanning a light beam in a controlled fashion. Suitable scan engines/means for scanning can be fabricated using galvanometer-controlled mirrors (as depicted in FIG. 2), piezoelectric-controlled elements, or acousto-optical deflectors, polygonal scanners, diffraction gratings, microelectromechanical systems, and the like. The chosen scan engine/means for scanning is not critical to the functionality of the invention, so long as the means chosen will accurately, precisely, and reliably scan the incoming light beam 10 in a desired, pre-set (and preferably programmable and/or user-definable) fashion across the sample.

Continuing with FIG. 2, after reflecting off mirrors 16 and 16′ the incoming light beam 10 has been converted to a scanned incoming light beam 12. The scanned beam 12 then enters a polarizing beam combining cube 18 that is operationally linked to a beam-combining dichroic mirror 19.

At this point, a second light source (not shown in FIG. 2) emits an excitation light beam 20 which enters the polarizing beam combining cube 18 at a face orthogonal to the face at which the scanned incoming light beam 12 enters the cube 18. The cube 18 thus combines the scanned incoming light beam 12 and the excitation light beam 20, to yield a combined light beam 30 (depicted as the two arrows at the lower left of FIG. 2). The combined light beam 30 is then used to irradiate the sample, thereby generating a return light beam 40. The dichroic mirror 19 functions to direct the combined light beam 30 toward the sample, while simultaneously passing the return light beam 40 back to the scan engine, where the return light path 40 (i.e., the emission from the sample) is descanned and passed to a confocal aperture (not shown).

Thus, in operation, the incoming light beam 10 is passed through the scan engine (14, 16, 14′, and 16′) and is then combined with an excitation light beam 20 via means for combining the scanned incoming light beam and the excitation light beam (depicted in FIG. 2 as the polarizing beam-combining cube 18). The combined beam 30 is then directed toward the sample via the dichroic mirror 19. The return light beam emitted from the sample is passed through dichroic 19, back through the scan engine (where it is descanned) and then passed to a confocal aperture (not shown in FIG. 2).

Several advantages are generated using this arrangement of a scanned incoming light beam and an additional excitation light beam. First, by combining the incoming light beam with the excitation beam after the incoming light beam has been scanned (i.e. the excitation beam does not pass through the scan engine), the excitation light beam can be of the same wavelength as the incoming light beam, without losing fluorescent emission collection efficiency or excitation input efficiency. In other words, the incoming light beam is generated and scanned independently of the excitation light beam. The two independent beams are then combined prior to their being directed toward the sample to be irradiated. The excitation beam is also separate from the return light path 40, which passes through dichroic 19 for descanning. In short, in the embodiment shown in FIG. 2, the excitation light beam 20 is not colinear with the first incoming light beam 10 or the return light beam 40, and the excitation light beam is not scanned.

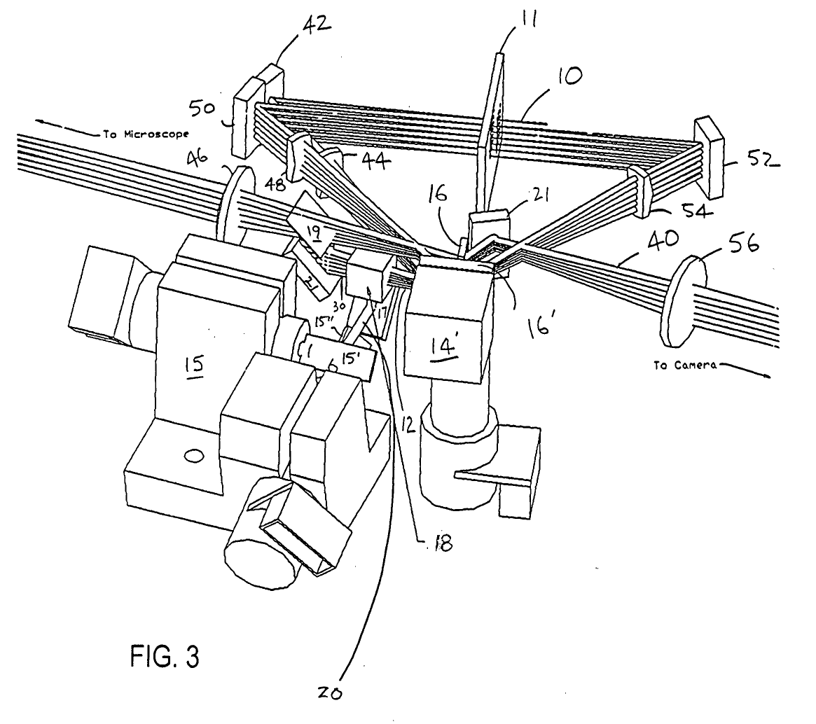

However, in another embodiment of the invention, the excitation light beam 20 can be scanned. In this embodiment, shown in FIG. 3 and described in greater detail below, a second scan engine (which can be of-the same configuration or different from the first scan engine) scans the excitation light beam 20 before it enters the polarizing beam-combining cube 18. By selecting an appropriate dichroic mirror 19, the excitation beam 20 may be the same wavelength as the incoming light beam 10 or a different wavelength.

The independent excitation light beam 20 provides a means to irradiate the sample with a combined light beam 30 that can include, for example, a constant wavelength excitation beam (of the same or different wavelength than the incoming beam 10) or a pulsed laser signal. This allows many different protocols, such as single- or two-photon imaging, ablation, photoactivation, and FRAP, to be accomplished quickly and easily, with a minimal amount of machine set-up time.

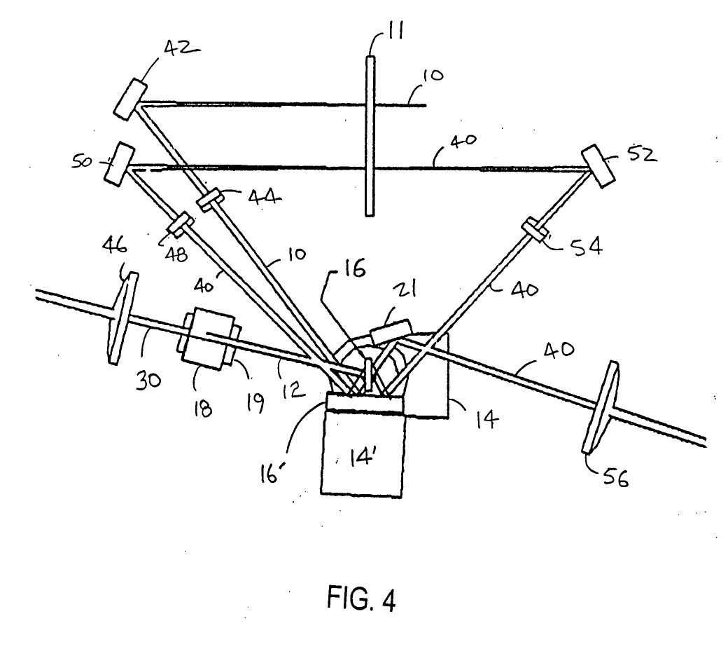

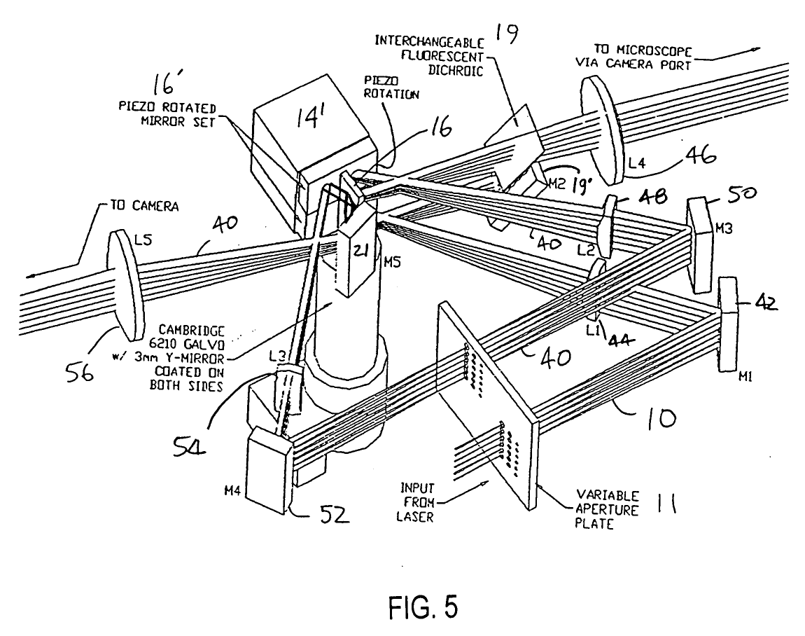

A more complete illustration of the above preferred embodiment, including various ancillary mirrors and lenses, as well as a scan engine for the excitation beam light beam 20 is depicted in FIGS. 3, 4, and 5 (where the reference numerals in each figure represents the same elements throughout). FIG. 3 and FIG. 5 are opposing-view perspective renderings, while FIG. 4 is a top plan view (with certain elements and light paths omitted for sake of clarity). The incoming light beam 10 produced by a light source, preferably a laser (not shown) first passes through a confocal aperture plate 11. The aperture plate may contain a single aperture or an array of apertures as described in Vogt et al., U.S. Patent Application Publication No. 20020141051, published Oct. 3, 2002, the entire content of which is incorporated herein. The aperture plate may be fixed or it may be translatable. An array of apertures is preferred. The incoming light beam then reflects off a first mirror 42 through lens 44, and is directed to a scan engine comprised of scanner 14 (see FIG. 4) and its corresponding mirror 16 and orthogonal scanner 14′ and its corresponding mirror 16′. Preferably, the scanners are a piezo- or galvanometer-controlled scanners that drive their corresponding mirrors. In the same fashion as in FIG. 2, the scan engine depicted in FIGS. 3, 4 and 5 generates a scanned light beam 12. The scanned light beam 12 then passes through the polarizing beam-combining cube 18.

Referring specifically to FIG. 3, a second light source (obscured from view in FIG. 3) generates an excitation beam 20 that is scanned through a scan engine comprised of a controller 15 and orthogonally-oriented mirrors 15′ and 15″, which function to scan the excitation beam. Mirror 17 functions to direct the scanned excitation light beam into the polarizing beam-combining cube 18, where the scanned incoming light beam 12 is combined with the excitation light beam to yield the combined light beam 30. Mirror 21 (or 19′ in FIG. 5) directs the combined light beam 30 into the dichroic mirror 19. It is at this point that the combined light beam 30 and the return (emission) light beam are briefly colinear.

The path of the return light beam (i. e., the emission light path) 40 is best shown in FIGS. 4 and 5. The return (emitted) light beam 40 follows (in the opposite direction) the same path as the incoming light to the point of the dichroic mirror 19. At this point, the return light passes through the dichroic mirror 19 thereby resulting in the divergence of the incoming and return beam paths. The diverged return light beam 40 then passes through the scan engine in reverse, thereby being de-scanned. Thus, as shown best in FIG. 5, the return light beam is reflected from scanner mirrors 16 and 16′ and is then directed back through the emission side of the confocal aperture plate 11 (via lens 48 and mirror 50).

After passing through the confocal plate 11, the return light path is directed back to the scan engine via mirror 52 and lens 54. As shown in FIG. 5, the scanner mirror 16 is two-sided. Thus, after exiting lens 54, the return light path is again scanned by lenses 16′ and 16 (acting in concert) and is then directed to the camera or other detection device via mirror 21 and lens 56.

The various lenses, mirrors, and sub-assemblies described herein, specifically the lenses 44, 46, 48, 54 and 56, the galvanometer-driven mirrors 16, 16′ and 21, the return lenses, the dichromic mirror 19, the beam-combining cube 18, etc., are all depicted in the figures as single lenses or mirrors. This may or may not be the case and is only used in the drawing figures for brevity and clarity. Each “lens” and “mirror” may comprise any number of lenses and/or mirrors to accomplish the goal of moving the light path from the input source to the sample and returning the reflected light to the photodetector. Thus, where appropriate, these structures are referenced in terms of the functional result to be obtained. For example, the term “beam-combining means” refers to any structure, such as a dichroic mirror or suitable lens or lenses, or any combination of lenses or mirrors which accomplish the functional goal of combining two independent light beams Lenses, mirrors, galvanometers, acoustical-optical devices, beam-combiners and the like, suitable for use in the present invention, may be obtained from any number of commercial suppliers. For example, suitable optical components can be obtained from GSI Lumonics (Billerica, Mass.), JML Direct Optics (Rochester, N.Y.), and Chroma Technologies (Brattleboro, Vt.).

The photodetector used in the invention may be any type of image detector now known or developed in the future for processing light (i.e., electromagnetic radiation, including, without limitation, visible, UV, IR, and X-rays) into images or digital data streams that can be further manipulated via computer. Included within this definition are digital cameras, film cameras, charge-coupled devices of any and all description, photomultiplier tubes, and single and multichannel photon detectors of any and all description. Collectively, these devices are referred to herein as photodetection means or simply a “photodetector.” In short, the photodetector used in the invention is not critical, so long as the chosen device functions to detect the particular wavelength of radiation used in the invention. Photodetectors suitable for use in the present invention can be obtained from numerous commercial suppliers, including Hamamatsu Corporation (Bridgewater, N.J.) and Roper Scientific (Trenton, N.J.).

Likewise, the light source used in the subject invention can be any type of light source that generates the desired wavelength of electromagnetic radiation. A laser light source is preferred. Suitable light sources are available commercially from suppliers such as Melles Griot (Carlsbad, Calif.) and Coherent Laser Group (Santa Clara, Calif.).

It is understood that the invention is not confined to the particular construction and arrangement of parts herein illustrated and described but embraces such modified forms thereof as come within the scope of the following claims.

1. A confocal microscope comprising:
a first scan engine dimensioned and configured to scan a first incoming light beam prior to the first incoming light beam irradiating a sample, thereby generating a scanned incoming light beam; and
a beam-combiner operationally linked to the first scan engine, wherein the beam-combiner is dimensioned and configured to combine the scanned incoming light beam with a second incoming light beam.

2. The confocal microscope of claim 1, wherein the beam-combiner is a polarizing beam-combining cube operationally linked to a dichroic mirror.

3. The confocal microscope of claim 1, further comprising a second scan engine dimensioned and configured to scan the second incoming light beam.

4. The confocal microscope of claim 3, wherein the first scan engine and the second scan engine are independently selected from the group consisting of a galvanometer-controlled mirror, a piezoelectric-controlled mirror, an acousto-optical deflector, a polygonal scanner, a diffraction grating, and a microelectromechanical system.

5. The confocal microscope of claim 3, further comprising a first light source for generating the first incoming light beam, wherein the first light source is operationally linked to the first scan engine; and a second light source for generating the second incoming light beam, wherein the second light source is operationally linked to the second scan engine.

6. The confocal microscope of claim 1, further comprising a first light source for generating the first incoming light beam, wherein the first light source is operationally linked to the first scan engine.

7. The confocal microscope of claim 1, further comprising a second light source for generating the second incoming light beam, wherein the second light source is operationally linked to the beam-combiner.

8. The confocal microscope of claim 1, further comprising a first light source for generating the first incoming light beam, wherein the first light source is operationally linked to the first scan engine; and a second light source for generating the second incoming light beam, wherein the second light source is operationally linked to the beam-combiner.

9. The confocal microscope of claim 8, further comprising a second scan engine operationally linked to the second light source and dimensioned and configured to scan the second incoming light beam.

10. The confocal microscope of claim 8, wherein the first scan engine and the second scan engine are independently selected from the group consisting of a galvanometer-controlled mirror, a piezoelectric-controlled mirror, an acousto-optical deflector, a polygonal scanner, a diffraction grating, and a microelectromechanical system.

11. The confocal microscope of claim 8, wherein the first light source is dimensioned and configured to generate a first incoming light beam of a first wavelength and the second light source is dimensioned and configured to generate a second incoming light beam of a second wavelength, and wherein the first wavelength and the second wavelength are the same.

12. The confocal microscope of claim 8, wherein the first light source is dimensioned and configured to generate a first incoming light beam of a first wavelength and the second light source is dimensioned and configured to generate a second incoming light beam of a second wavelength, and wherein the first wavelength and the second wavelength are different.

13. A confocal microscope comprising:
a first light source for generating a first incoming light beam, wherein the first light source is operationally linked to a first scan engine dimensioned and configured to scan the first incoming light beam prior to the first incoming light beam irradiating a sample, thereby generating a scanned incoming light beam; and
a second light source for generating the second incoming light beam, wherein the second light source is operationally linked to a beam-combiner which is operationally linked to the first scan engine, wherein the beam-combiner is dimensioned and configured to combine the scanned incoming light beam with the second incoming light beam.

14. The confocal microscope of claim 13, further comprising a second scan engine operationally linked to the second light source and dimensioned and configured to scan the second incoming light beam.

15. The confocal microscope of claim 14, wherein the first scan engine and the second scan engine are independently selected from the group consisting of a galvanometer-controlled mirror, a piezoelectric-controlled mirror, an acousto-optical deflector, a polygonal scanner, a diffraction grating, and a microelectromechanical system.

16. The confocal microscope of claim 14, wherein the first light source is dimensioned and configured to generate a first incoming light beam of a first wavelength and the second light source is dimensioned and configured to generate a second incoming light beam of a second wavelength, and wherein the first wavelength and the second wavelength are the same.

17. The confocal microscope of claim 14, wherein the first light source is dimensioned and configured to generate a first incoming light beam of a first wavelength and the second light source is dimensioned and configured to generate a second incoming light beam of a second wavelength, and wherein the first wavelength and the second wavelength are different.

18. A confocal microscope comprising:
a first light source for generating a first incoming light beam, wherein the first light source is operationally linked to a first scan engine dimensioned and configured to scan the first incoming light beam prior to the first incoming light beam irradiating a sample, thereby generating a scanned incoming light beam;
a second light source for generating the second incoming light beam, wherein the second light source is operationally linked to a second scan engine dimensioned and configured to scan the second incoming light beam to yield a scanned second incoming light beam; and
a beam-combiner which is operationally linked to the first scan engine and the second scan engine, wherein the beam-combiner is dimensioned and configured to combine the first scanned incoming light beam with the second scanned incoming light beam.

19. The confocal microscope of claim 18, wherein the first light source is dimensioned and configured to generate a first incoming light beam of a first wavelength and the second light source is dimensioned and configured to generate a second incoming light beam of a second wavelength, and wherein the first wavelength and the second wavelength are the same.

20. The confocal microscope of claim 18, wherein the first light source is dimensioned and configured to generate a first incoming light beam of a first wavelength and the second light source is dimensioned and configured to generate a second incoming light beam of a second wavelength, and wherein the first wavelength and the second wavelength are different.
